(19) United States
(12) Patent Application Publication
(10) Pub. No.: US 2015/0136568 A1
(43) Pub. Date: May 21, 2015

(54) CONVEYOR SYSTEM PROVIDED WITH PLURALITY OF CARRIERS

(71) Applicant: FUJITSU LIMITED, Kawasaki-shi (JP)

(72) Inventors: Satoru MATSUMOTO, Kahoku (JP); Koukichi NAKATANI, Kahoku (JP)

(21) Appl. No.: 14/488,504

(22) Filed: Sep. 17, 2014

(30) Foreign Application Priority Data
Nov. 20, 2013 (JP) 2013-240241

(51) Int. Cl. B65G 35/06

(52) U.S. Cl. CPC B65G 35/06
USPC 198/710

(57) ABSTRACT

A conveyor system equipped with a roller track for holding and moving one side of material and a plurality of rails parallel to the roller track each having a carrier for holding and moving the other side of material on the rail, wherein each carrier is provided with a height adjuster for changing holding height of material, the holding height of material is raised after a carrier departs from the start point and the height adjuster engages with an operating bar which is set at a side of the rail, the holding height of material is lowered after a carrier departs from the end point toward the start point and the height adjuster engages with another operating bar which is set at a side of the rail, and the carrier which returns to the start point can pass below the material which moves while held at the carrier.

### CROSS-REFERENCE TO RELATED APPLICATION

This application claims priority from, and incorporates by reference the entire disclosure of, Japanese Patent Application No. 2013-240241, filed on Nov. 20, 2013.

### FIELD

The present application relates to a conveyor system which makes a plurality of carriers move back and forth to convey material from one point to another point.

### BACKGROUND

In the past, in factories etc., conveyor systems have been used to place manufactured products, semifinished products, and other materials on carriers and transport them from one point to another point in the factory. In such conveyor systems, in general, the material is transported in a state carried on pallets. Among such conveyor systems, there are conveyor systems which do not use power but transport pallets which roll on slanted roller tracks, but there are also conveyor systems which transport pallets with first sides placed on carriers which run along rails and with other sides placed on roller tracks. The roller tracks in this case can be formed by arranging along the rails free roller units provided with sets of rollers comprised of large numbers of fixed rollers in lines.

Further, a pallet which is carried on a carrier which runs on a rail and moves from one point (start point) to another point (end point) is taken off together with the material from the carrier and roller track. The carrier runs on the rail in the opposite direction to return to the start point for transporting the next pallet. That is, the carrier continues moving back and forth on the rail between the start point and the end point of the pallet. If the frequency of transport of material is low, a single conveyor path provided with a roller track and rail can be used to make a single carrier move back and forth.

Further, when the frequency of transport of material between the two points is high, two or more sets of rails and roller tracks at provided as transport paths. If using a plurality of transport paths to transport material, the amount of transport per unit time can be increased. On the other hand, a conveyor system which provides two rails in close proximity and enables the rails to be moved up and down so that a carrier in the middle of transporting material and a carrier which is returning to the original position do not collide in the middle is disclosed in Japanese Patent Publication No. 8-175641A. In the conveyor system which is disclosed in Japanese Patent Publication No. 8-175641A, a carrier runs at the upper side when moving forward and runs at the lower side by the lowering the rail when moving back, so carriers will not collide.

In this regard, in the conveyor system which is disclosed in Japanese Patent Publication No. 8-175641A, the heights of the rails are changed during the back and forth motion of the carriages, so when the rails are long, there is the issue that realization is difficult. Further, to raise and lower the rails as a whole, in addition to power for moving the carriages, a separate power source such as an electric motor or hydraulic device for moving the rails up and down is required under the rails and therefore the cost of the conveyor system rises.

### SUMMARY

In one aspect, the present application provides a conveyor system which transports material by making one end roll on a roller track and which holds the other end of the material by a carrier to make it move, whereby it is possible to just increase the carriers and rails so as to deal with increases in the amount of transport of material at a low cost.

According to one aspect of the embodiments, there is provided a conveyor system which transports material from a start point to an end point, provided with a roller track which is laid from the start point to the end point and which makes the material move while holding first ends by a set of rollers, at least two rails which are set in parallel a predetermined distance away from the roller track from the start point to the end point, carriers which can independently run on the rails and at which other ends of the material are held, and operating members which are provided at the sides of the start point sides and the end point sides of the rails and which engage with the carriers right after departing from the start point and the carriers right after departing from the end point to change the states of the carriers, each carrier provided with a carriage which runs on the rails, a holder which is provided at a top of the carriage and holds material, and a height adjustment mechanism which is provided between the carriage and the holder and engages with the operating members to change a height of the holder from the carriage, a height of the holder which the height adjustment mechanism changes to when the operating member at the end point side engages with the height adjustment mechanism being lower than a height of the holder which the height adjustment mechanism changes to when the operating member at the start point side engages with the height adjustment mechanism.

### BRIEF DESCRIPTION OF DRAWINGS

FIG. 1A is a perspective view of a conveyor system which is provided with two transport paths of the comparative art.

FIG. 1B is a perspective view of a carrier which is used in the conveyor system which is illustrated in FIG. 1A.

FIG. 2 is a perspective view which illustrates a general configuration of the conveyor system of the present application.

FIG. 3A is a side view of a first embodiment of a carrier which is used in the conveyor system which is illustrated in FIG. 2.

FIG. 3B is a side view which illustrates operation of the carrier which is illustrated in FIG. 3A.

FIG. 4A is a side view which illustrates the state where carriers of the first embodiment of the present application are at a start point and an end point.

FIG. 4B is a side view which illustrates the state from the state which is illustrated in FIG. 4A where a carrier at the start point departs toward the end point and a carrier at the end point returns toward the start point.

FIG. 4C is a side view which illustrates the state where a carrier heading from the start point toward the end point and a carrier returning from the end point to the start point pass each other.

FIG. 4D is a side view which illustrates a carrier heading toward the start point and a carrier heating toward the end point.

FIG. 5 is a front view which illustrates a state where the two carriers which are illustrated in FIG. 4C pass each other.

FIG. 6 is a side view of a modified embodiment of the carrier which is illustrated in FIG. 3A.

FIG. 7 is an explanatory view which illustrates the positions of the sensors and operating bars in the conveyor system of the present application.

FIG. 8 is a flow chart which illustrates one example of a control operation of a carrier in the conveyor system of the present application.

FIG. 9A is a perspective view which illustrates a state of placement of a carrier at the rail in the present application.

FIG. 9B is a cross-sectional view of the carrier which is illustrated in FIG. 9A in a direction vertical to the rail.

FIG. 10A is a perspective view of a second embodiment of a carrier which is used in the conveyor system of the present application.

FIG. 10B is a partial enlarged view of the carrier which is illustrated in FIG. 10A.

FIG. 10C is a front view of a cam and arms which are illustrated in FIG. 10B.

FIG. 11A is a disassembled perspective view of a cam unit which is illustrated in FIG. 10B.

FIG. 11B is a plan view after assembly of a height adjustment mechanism which is illustrated in FIG. 11A.

FIG. 11C is a perspective view after assembly of the height adjustment mechanism which is illustrated in FIG. 11A.

FIG. 12A is a perspective view which illustrates an overall configuration of the conveyor system of the present application.

FIG. 12B is an explanatory view which illustrates the state where positions of the arms and cam of the height adjustment mechanism are changed by operating bars when a carrier moves back and forth in the conveyor system which is illustrated in FIG. 12A.

FIG. 13A is a perspective view which illustrates the state where the height adjustment mechanism of a carrier which has departed from the start point strikes an operating bar.

FIG. 13B is a front view which illustrates positions of the cam and the arms in the state of FIG. 13A.

FIG. 13C is a perspective view which illustrates the state where the height adjustment mechanism of a carrier passes an operating bar from the state of FIG. 13A.

FIG. 13D is a front view which illustrates positions of the cam and arms in the state of FIG. 13C.

FIG. 13E is a perspective view which illustrates the state where the height adjustment mechanism of a carrier passes an operating bar from the state of FIG. 13C.

FIG. 13F is a front view which illustrates positions of the cam and the arms in the state of FIG. 13E.

FIG. 14A is a perspective view which illustrates the state where the height adjustment mechanism of a carrier strikes a next operating bar from the state of FIG. 13E.

FIG. 14B is a front view which illustrates positions of the cam and the arms in the state of FIG. 14A.

FIG. 14C is a perspective view which illustrates the state where the height adjustment mechanism of a carrier strikes the next operating bar from the state of FIG. 14A.

FIG. 14D is a front view which illustrates positions of the cam and the arms in the state of FIG. 14C.

FIG. 14E is a perspective view which illustrates the state where the height adjustment mechanism of a carrier passes an operating bar from the state of FIG. 14C.

FIG. 14F is a front view which illustrates positions of the cam and the arms in the state of FIG. 14E.

FIG. 15 is a perspective view which illustrates operation of a ratchet stopper at a start point side which is provided at a carrier of the present application.

FIG. 16A is a side view which illustrates one example of the structure of a track at an end point of a conveyor system of the present application.

FIG. 16B is a front view which illustrates separation of material from a carrier in FIG. 16A.

FIG. 17A is a perspective view which illustrates an embodiment in which three tracks are provided in the conveyor system of the present application.

FIG. 17B is a front view of a conveyor system which is illustrated in FIG. 17A.

FIG. 18A is a front view which illustrates an issue in the case where a pallet is carried at a carrier at a side closest to a free roller unit.

FIG. 18B is a front view which illustrates a structure which deals with the issue which is illustrated in FIG. 18A.

### DESCRIPTION OF EMBODIMENTS

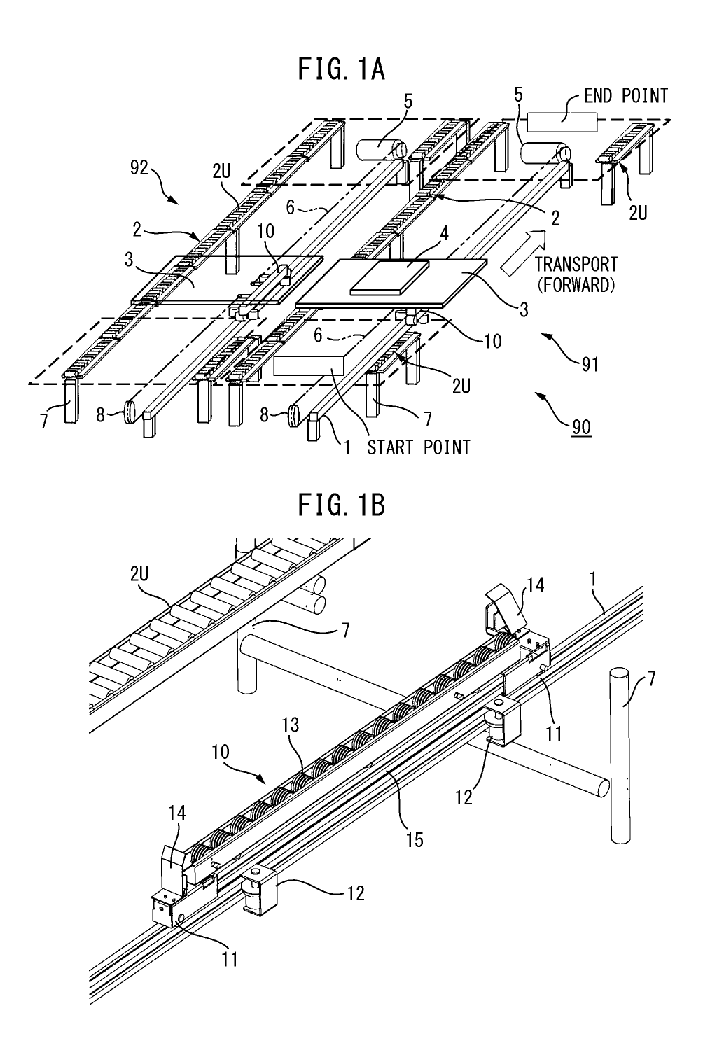

Below, the attached drawings will be used to describe embodiments of the present application in detail based on specific examples, but before explaining embodiments of the present application, a conveyor system of the comparative art will be explained using FIG. 1A and FIG. 1B.

FIG. 1A illustrates an example of a conveyor system 90 which is installed in a factory etc. The conveyor system 90 of this example illustrates the state where the amount of transport is increased by providing two lines of a first conveyor line 91 and a second conveyor line 92 in parallel. The first conveyor line 91 and the second conveyor line 92 are completely the same in structure, so here only the first conveyor line 91 will be explained. The component members of the second conveyor line 92 will be assigned the same reference notations as the component members of the first conveyor line 91 and explanations will be omitted.

At the first conveyor line 91, there are a rail track 1 which is supported by legs 7 (hereinafter simply referred to as a “rail”) and a roller track 2 which is similarly supported by legs 7. The rail 1 and the roller track 2 are arranged in parallel. The rail 1 is a single iron rail which runs from the start point to the end point, but the roller track 2 is usually formed by a plurality of free roller units 2U connected together.

Further, the free roller units 2U are, if necessary, arranged at the start point and the end point in single units and are used for applications where pallets 3 which carry products 4 before transport and pallets 3 which carry products 4 after transport are temporarily placed. On the rail 1, there is a carrier 10 which runs which carrying one end of a pallet 3. The carrier 10 is connected to a belt (or wire) 6 which is laid between a motor 5 and a pulley 8 and is pulled by the belt (or wire) 6 to move on the rail 1.

FIG. 1B illustrates the structure of this carrier 10. Note that, FIG. 1B omits illustration of the belt (or wire) 6. At the carrier 10, rollers 11 for running use are provided before and after a main body 15. In the vicinity of the running rollers 11, there are guide rollers 12 for enabling the carrier 10 to run on the rails 1 without detaching from the rail 1. The carrier 10 in this example is provided with rubber rollers 13 at the top part of the main body 15. Ratchet stoppers 14 are provided at the end parts of the main body 15 in the front-back direction. The rubber rollers 13 are for increasing the friction with the pallet 3 which is carried on the carrier 10. The direction perpendicular to the direction of advance of the pallet 3 is held. Further, the ratchet stoppers 14 restrict movement of the pallet 3 which is carried on the rubber rollers 13 in the front-back direction.

In this regard, the conveyor system 90 which is illustrated in FIG. 1A is large in installation area and requires structures corresponding to the number of conveyor lines. The present application deals with this issue. Below, an embodiment of the present application will be explained in detail based on a specific example. Note that, to simplify the explanation, members the same as members which are used in the conveyor system 90 of the comparative art which is explained in FIG. 1A and FIG. 1B are assigned the same reference notations. In the present application, a conveyor system is provided which can make the amount of transport the same in extent or greater than that of the conveyor system 90 which is illustrated in FIG. 1A and can halve the installation area.

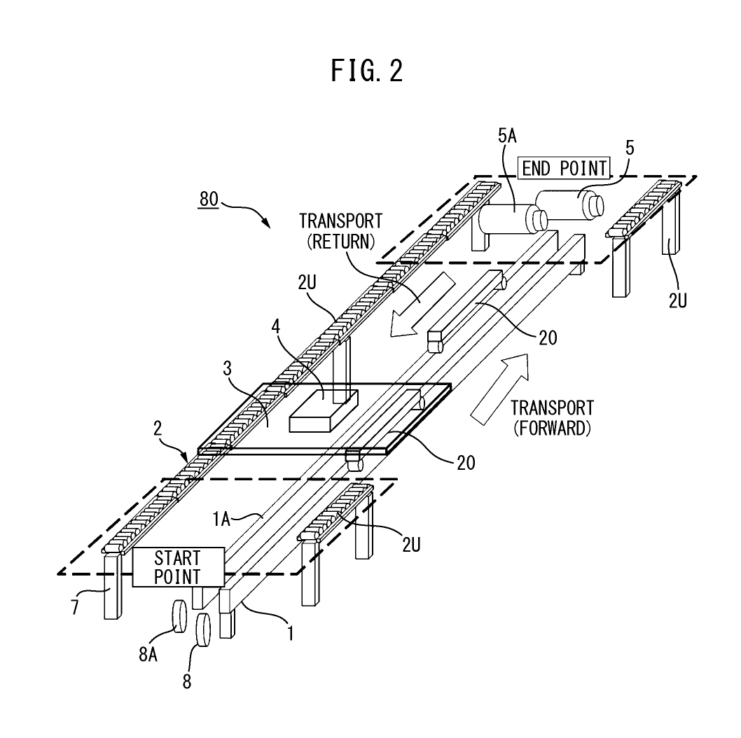

FIG. 2 illustrates the general configuration of a conveyor system 80 of one embodiment of the present application. The conveyor system 80 of this embodiment has a rail 1 which is supported by legs 7 and a roller track 2 which is supported by legs 7. The rail 1 and the roller track 2 are arranged in parallel. The roller track 2 is formed by a plurality of free roller units 2U connected together. Further, in this embodiment, a rail 1A is added in parallel at an inside of the rail 1. The rail 1A can also be added at the outside of the rail 1, but to prevent an increase in the installation area of the conveyor system 80, in this embodiment, the rail 1A is set at the inside of the rail 1.

At the rail 1A which is added to the rail 1, a carrier which runs while carrying one end of the pallet 3 is provided. However, if providing carriers 10 which are illustrated in FIG. 1B as is on the rail 1 and rail 1A, when one carrier 10 transports a pallet from the start point to the end point, if another carrier 10 returns from the end point to the start point, the returning carrier 10 is liable to collide with the pallet 3. Therefore, for the carrier of the conveyor system 80 of the embodiment which is illustrated in FIG. 2, a carrier 20 of a structure which will not collide with a pallet 3 while passing it is used. The point of carriers 20 running on the rail 1 and rail 1A by belts (or wires) (not illustrated) which are laid between motors 5 and pulleys 8 is the same.

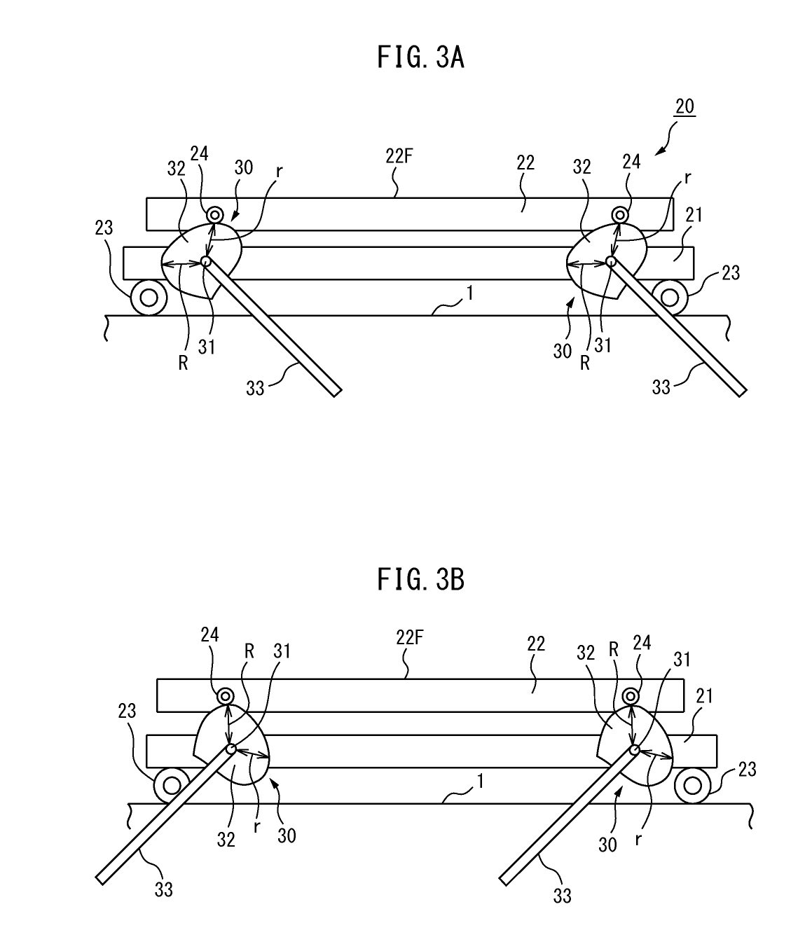

FIG. 3A is a side view which illustrates the structure of the carrier 20 of the first embodiment which is used for the conveyor system 80 which is illustrated in FIG. 2. The structures of the carriers 20 which run on the rail 1 and the rail 1A may be the same, so the structure of the carrier 20 which is made to run on the rail 1 will be explained. The carrier 20 is provided with a carriage 21 which runs on the rail 1, a holder 22 which is provided at the top part of the carriage 21 and holds material such as a pallet, and height adjustment mechanisms 30 which are provided between the carriage 21 and the holder 22 and change the height from the carriage 21 of the holder 22.

The carriage 21 is provided with running wheels 23 in the front-back direction (end point direction being defined as the front direction, while the start point direction being defined as the back direction). In actuality, the running wheels 23 include guide rollers which prevents the running wheels 23 from detaching from the rail 1, but illustration here is omitted. The holder 22 has a top surface which functions as a holding surface 11F which holds material, while is provided with elevating wheels 24 which engage with the height adjustment mechanisms 30 at the two side surfaces in the front-back direction.

Each height adjustment mechanism 30 is provided with a cam 32 which rotates by a shaft 31 which is supported at the carriage 21 and an arm 33 which is attached to the shaft 31 and rotates together with a cam 32. In the present embodiment, the front end of the arm 33 sticks out to the outside from the contour of the cam 32, but the length of the arm 33 is not particularly limited. Further, the cam 32 has at its contour a part with the shortest distance from the shaft 31 (called the “small radius part r”) and a part with the longest distance from the shaft 31 (called the “large diameter part R”). The diameter of the cam 32 continuously changes from the small diameter part r to the large diameter part R. The state which is illustrated in FIG. 3A is the state where the elevating wheels 24 of the holder 22 are supported by the small diameter parts r of the cams 32. Note that, each cam 32 is designed to be able to change in diameter in a range of exactly the distance between the shortest small diameter part r and the longest large diameter part R from the shaft 31.

Further, if the arm 33 turns clockwise from the state which is illustrated in FIG. 3A, the elevating wheel 24 of the holder 22 runs on the contour of the cam 32. Further, while not illustrated, the position of the holder 22 on the carriage 21 is designed not to change, so if the cams 32 rotate and change in diameter from the small diameter parts r to the large diameter parts R, the holder 22 rises from the carriage 21. The state where the cams 32 rotate and the elevating wheels 24 of the holder 22 are supported by the large diameter parts R of the cams 32 is illustrated in FIG. 3B. In the state which is illustrated in FIG. 3A and the state which is illustrated in FIG. 3B, a difference of exactly the distance (R-r) arises in the height of the holding surface 22F of the holder 22 from the carriage 21.

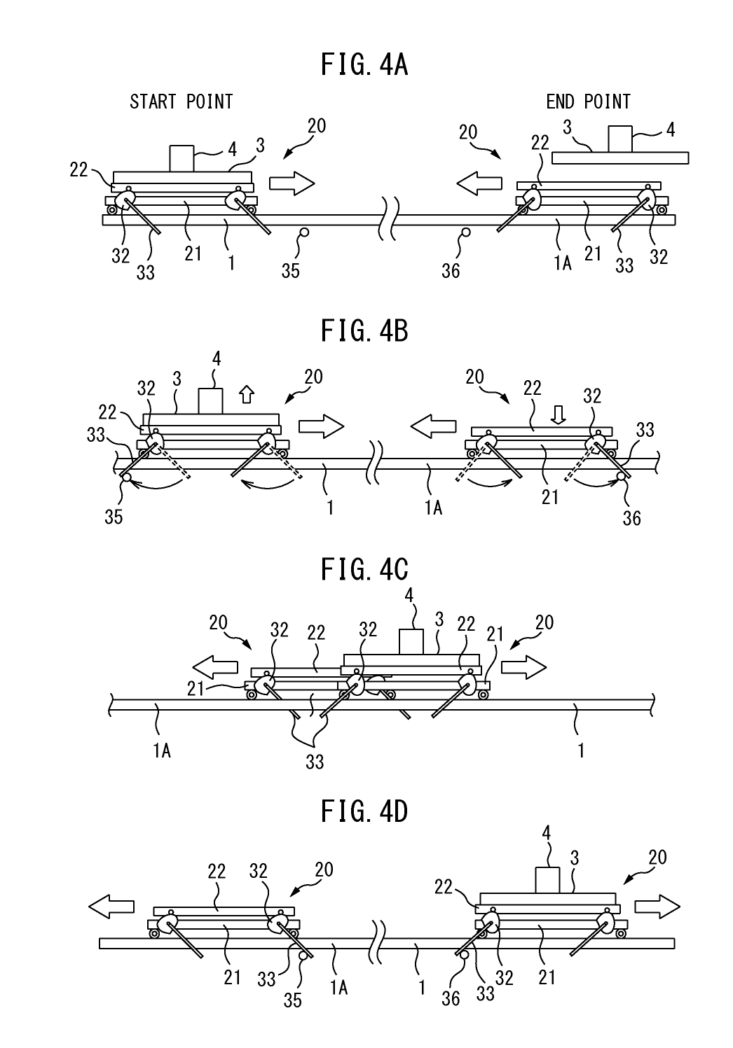

Here, FIG. 4A to FIG. 4D will be used to explain placing products 4 on pallets 3 of carriers 20 and a carrier 20 heading from the start point toward the end point and a carrier 20 returning from the end point to the start point passing each other. In this explanation, assume that a carrier 20 which carries a product 4 on a pallet 3 and heads from the start point toward the end point runs on the rail 1 and that a carrier 20 which has discharged the pallet and returns from the end point to the start point runs on the rail 1A. Further, in the conveyor system 80 which is provided with the carriers 20, near the start point and the end point, operating bars 35 and 36 are provided as operating members for engaging with arms 33 which are provided at the carriers 20 which depart from the start point and end point and making these turn. The operating bars 35 and 36 can be provided supported in the horizontal direction by leg members which are attached to the floor. The positions of the operating bars 35 and 36 are at positions higher than the front end parts of the arms 33 when the cams 32 are at the positions which are illustrated at FIG. 3A and the positions which are illustrated in FIG. 3B.

FIG. 4A illustrates the state where carriers 20 are at the start point and the end point. It illustrates the state where the carrier 20 which is at the start point holds a pallet 3 on which a product 4 is carried and where the pallet 3 which carries the product 4 is taken off from the carrier 20 at the end point. When the carrier 20 is at the start point, the arms 33 are in the state which is illustrated in FIG. 3A, the holder 22 is in the state closest to the carriage 21, and the height of the holder 22 from the carriage 21 is low. Further, when a carrier 20 is at the end point, the arms 33 are in the state which is illustrated in FIG. 3B, the holder 22 is in the state farthest from the carriage 21, and the height of the holder 22 from the carriage 21 is high.

As illustrated in FIG. 4A by the arrows, assume that the carrier 20 at the start point has departed toward the end point and the carrier 20 at the end point has departed toward the start point. This being so, as illustrated in FIG. 4B, the arms 33 of the carrier 20 which has departed from the start point engage with the operating bar 35 while the arms 33 of the carrier 20 which has departed from the end point engage with the operating bars 36. FIG. 4B illustrates the state where the two arms 33 engage with the operating bars 35 and 36. If the arms 33 engage with the operating bars 35 and 36, the arms 33 are turned by the operating bars 35 and 36 in accordance with running of the carrier 20.

After the carrier 20 departs from the start point, the first arm 33 which engages with the operating bar 35 turns clockwise to make the cam 32 rotate. As explained in FIG. 3A and FIG. 3B, the cam 32 cause the height of the holder 22 of the carrier 20 from the carriage 21 to rise. As explained above, the cam 32 is made able to change in diameter in a range of exactly the distance between the shortest small diameter part r and longest large diameter part R. For this reason, the cam 32 which has rotated by the arm 33 which engages with the operating bar 35 stops at a position where the large diameter part R with the longest distance from the shaft 31 of the cam 32 supports the holder 22.

In the state where the cam 32 has stopped rotating, the arm 33 is still at a position not riding over the operating bar 35. To make the arm 33 ride over the operating bar 35, the arm 33 may be given flexibility or a mechanism which makes just the arm 33 turn further in the clockwise direction with respect to the cam 32, makes the arm 33 ride over the operating bar 35, then returns to its original position is provided at the arm 33. This is because to make the arm 33 which has ridden over the operating bar 35 in this way hold its positions before riding over the operating bar 35, the arm 33 has to constantly engage with the operating bar 35 when the carrier 20 moves back and forth on the rail 1. The cam 32 and the arm 33 which pass the operating bar 35 hold their positions, so when the second arm 33 passes the operating bar 35, the height of the holder 22 as a whole is raised from the carriage 21.

On the other hand, the conveyor 20 which departs from the end point engages with the operating bar 36 whereby the first arm 33 turns counterclockwise and the cam 32 is made to rotate, then the cam 32 causes the height of the holder 22 of the carrier 20 from the carriage 21 to descend. The cam 32 which rotates due to the arm 33 which engages with the operating bar 36 stops at a position where the small diameter part r of the shortest distance from the shaft 31 of the cam 32 supports the holder 22. The cam 32 and arm 33 which pass the operating bar 36 hold their positions, so when the second arm 33 passes the operating bar 36, the height of the holder 22 as a whole becomes close to the carriage 21.

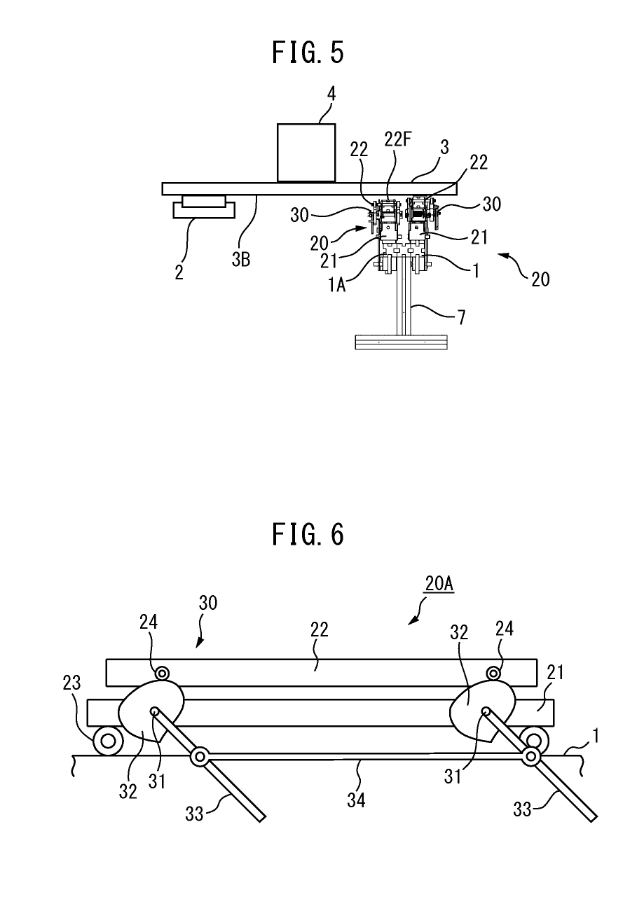

FIG. 4C illustrates the state where the carrier 20 which heads from the start point toward the end point and the carrier 20 which returns from the end point to the start point pass each other. This state seen from a direction vertical to the rails 1 and 1A is illustrated in FIG. 5. The height of the holder 22 of the carrier 20 which heads toward the end point from the carriage 21 rises due to the height adjustment mechanisms 30, while the height of the holder 22 of the carrier 20 which heads toward the start point from the carriage 21 descends due to the height adjustment mechanisms 30. Therefore, the height of the holding surface 22F of the holder 22 of the carrier 20 which heads toward the start point is at a position lower than the bottom surface 3B of the pallet 3 which is held by the holder 22 of the carrier 20 which heads toward the end point. Accordingly, the carrier 20 which heads toward the start point can pass the carrier 20 which heads toward the end point without contacting the held pallet 3.

FIG. 4D illustrates the carrier 20 which heads toward the start point and the carrier 20 which heads toward the end point. The carrier 20 which heads toward the start point passes the operating bar 35 before reaching the start point, while the carrier 20 which heads toward the end point passes the operating bar 36 before reaching the end point. However, the carrier 20 which heads toward the start point already changes in state by the operating bar 36, so is not changed in state by the operating bar 35 and reaches the start point in the state where the holder 22 is close to the carriage 21. Similarly, the carrier 20 which heads toward the end point already changes in state by the operating bar 35, so is not changed in state by the operating bar 36 and reaches the end point in the state where the holder 22 is far from the carriage 21.

As explained above, in the conveyor system 80 which is provided with the carriers 20 of the first embodiment at the rail 1 and the rail 1A and is illustrated in FIG. 2, it is possible to transport double the material from the start point to the end point compared with a conveyor system with a single rail. Further, just the heights of the holding surfaces 22F of the holders 22 of the carriers 20 are changed by the height adjustment mechanisms 30, it is possible to reduce the size of the height adjustment mechanisms 30 and prevent the carriers from becoming larger in size. Further, no power source for operating the height adjustment mechanisms 30 is required, so this does not lead to a large increase in cost of the conveyor system 60. Note that, the operating bars 35 and 36 need only be provided with the function of making the arms 33 turn, so they are not limited to bar-shaped members. For example, it is also possible to provide members which have plate shaped widths at the floor surface and have the arms engage with them.

FIG. 6 illustrates a modified embodiment of the carrier 20 which is illustrated in FIG. 3A. In the height adjustment mechanisms of the carrier 20 which is illustrated in FIG. 3A, two arms 33 engage with the operating bars 35 and 36, so unless both of the two arms 33 pass the operating bars 35 and 36, the holder 22 does not become horizontal with respect to the carriage 21. Therefore, in the carrier 20A of the modified embodiment, the two arms 33 are connected by a link 34. When one arm 33 strikes the operating bars 35 and 36, the other arm similarly turns.

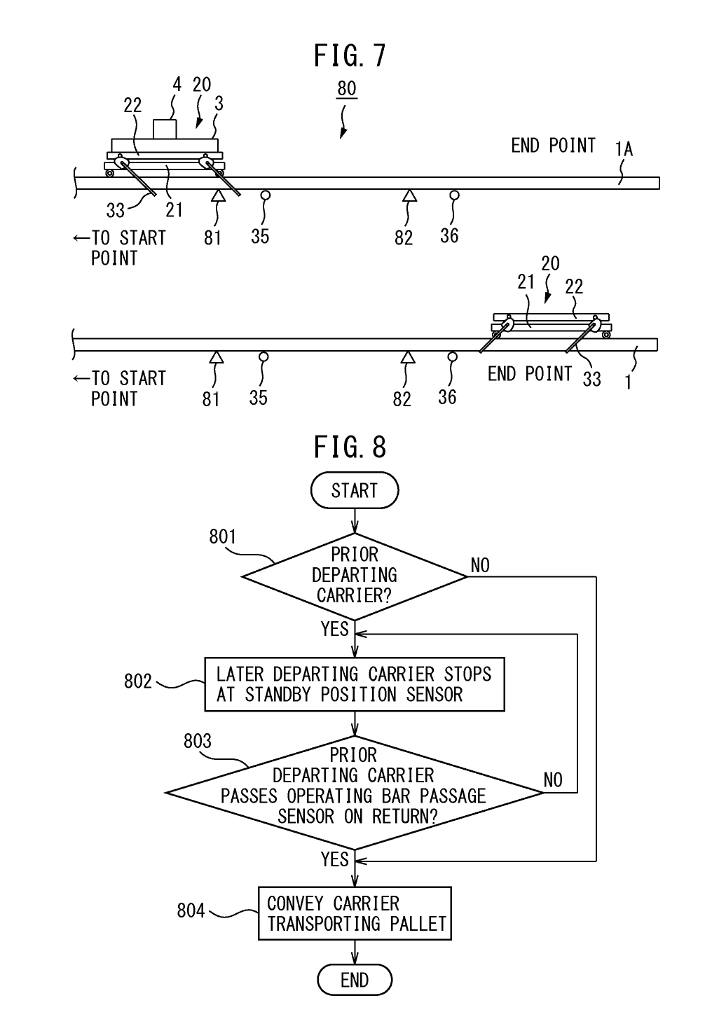

Therefore, one example of control so that, in the conveyor system 80, before the heights of the holders of the carriers 20 which are made to run on the two rails 1 and 1A are changed, the carriers 20 pass each other and the carriers 20 do not strike the pallets 3 will be explained using FIG. 7 and FIG. 8. That is, the section where the carriers 20 can freely pass each other is the inside of the two cam operating bars 35 and 36, but if passing each other in other sections, there is a possibility of the returning carrier 20 colliding with the material of the carrier being transported.

As illustrated in FIG. 7, for example, when there is a carrier 20 on the rail 1 at the end point, the position of the carrier 20 is detected by two position sensors so that the carrier 20 running on the rail 1A does not enter the end point. The first position sensor is a standby position sensor 81 which is provided at the side of each of the rails 1 and 1A of the start point side from the operating bar 35, while the second position sensor is an operating bar passage detection sensor 82 which is provided at the side of each of the rails 1 and 1A of the start point side from the operating bar 36. In this example, so long as the carrier 20 on the rail 1 does not pass the operating bar passage detection sensor 82 and move to the start point side, it is possible to make the carrier 20 on the rail 1A which departed from the start point stand by at the position of the standby position sensor 81 to thereby prevent collision.

FIG. 8 is a flow chart which illustrates one example of a control operation of a carrier 20 in the conveyor system 80 of the structure which is illustrated in FIG. 7. This control should be performed every time a carrier 20 which carries material departs from the start point. At step 801, it is judged if there is a prior departing carrier on another rail. If there is no prior departing carrier on another rail (NO), the routine proceeds to step 804 where the carrier which transports a pallet carrying a product is started. On the other hand, when it is judged at step 801 that there is a prior departing carrier on still another rail (YES), the routine proceeds to step 802.

At step 802, the transport of the carrier which transports a pallet carrying a product (later departing carrier) is started, but the later departing carrier stands by at the position of the standby position sensor and does not proceed any further. Further, at the next step 802, it is judged if the prior departing carrier is in the middle of returning to the start point and has passed the operating bar. When it is judged at step 802 that the prior departing carrier has not passed the operating bar (NO), the routine returns to step 802 where the later departing carrier is made to stand by at the position of the standby position sensor.

On the other hand, if it is judged at step 802 that the prior departing carrier passes the operating bar (YES), the routine proceeds to step 804 where the later departing carrier which had been kept on standby at the position of the standby position sensor starts to be transported. Due to this control, the prior departing carrier which is returning to the start point and the later departing carrier which is heading toward the end point always pass at the insides of the two cam operating bars 35 and 36. The carrier 20 which returns to the start point no longer strikes the material of the carrier being transported.

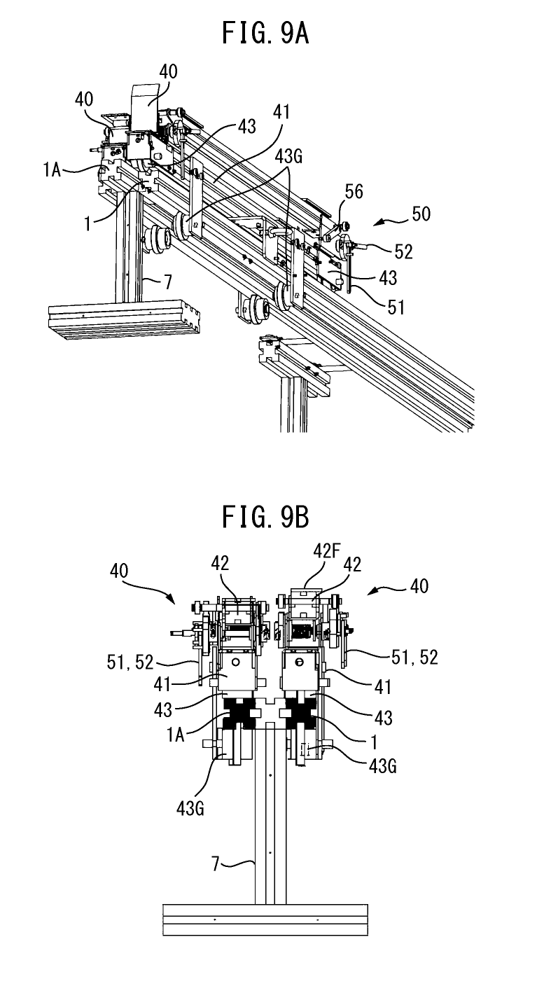

Next, the structure of the carrier 40 of the second embodiment which is used for the conveyor system 80 which is illustrated in FIG. 2 will be explained. FIG. 9A illustrates the state of provision of the carriers 40 at the rails 1 and 1A, while FIG. 9B is a view which illustrates a cross-section of the carriers 40 which are illustrated in FIG. 9A in a direction vertical to the rails 1 and 1A. The structure of the carrier 40 which runs on the rail 1 and the carrier 40 which runs on the rail 1A are the same except that the height adjustment mechanisms 50 are provided symmetrically, so the structure of the carrier 40 which runs on the rail 1 will be explained.

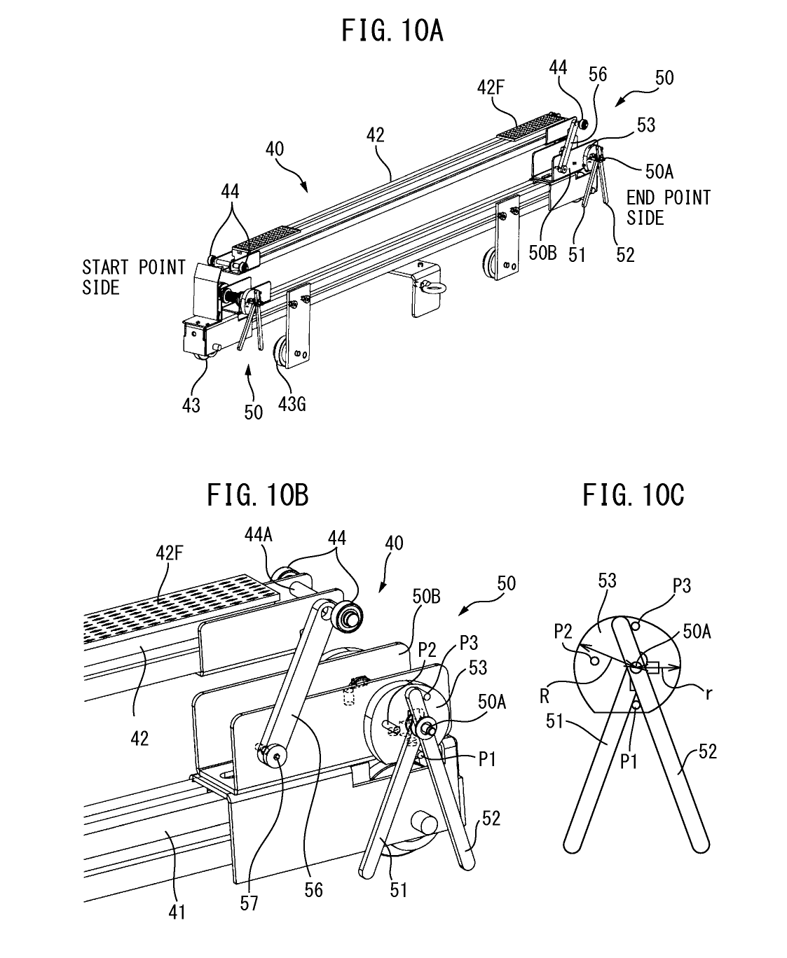

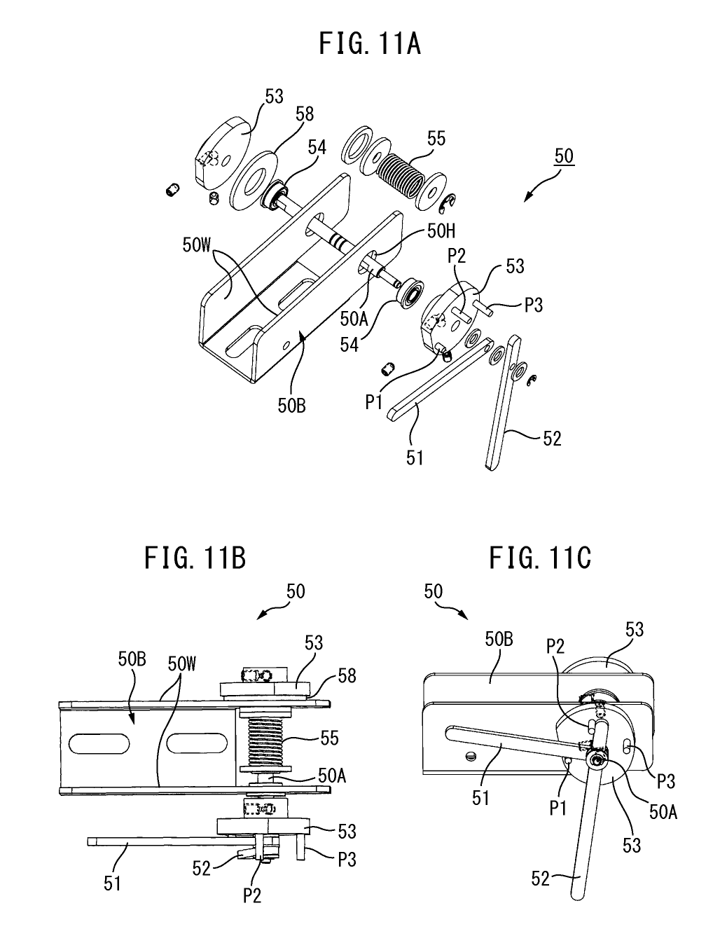

In the carrier 40 of the second embodiment, running wheels 43 are provided in the front-back direction of the carriage 41, while the other side surface of the carriage 41 is provided with guide wheels 43GA provided with projections. The guide wheels 43G guide the carrier 40 by projections which are provided at their outer circumferential surface running in grooves which are provided at the bottom surface of the rail 1. Therefore, the guide wheels 43G are not limited to ones provide with projections. For example, they may be also be guide wheels with grooves which use grooves for guidance. Further, the other side surface of the carrier 40 is provided with height adjustment mechanisms 50 which adjust the height of the holder 42 with respect to the carriage 41. Therefore, the structure of the height adjustment mechanisms 50 will be explained from FIG. 10A to FIG. 10C and from FIG. 11A to FIG. 11C.

FIG. 10A illustrates a state where the carrier 40 is detached from the rail 1 and the holder is separated from the carriage, while FIG. 10B illustrates partially enlarged the height adjustment mechanism 50 at the end point side of the carrier 40 which is illustrated in FIG. 10A. Further, FIG. 10C is a view which illustrates first and second arms 51 and 52 and a cam 53 which are illustrated in FIG. 10B as seen from the front. Furthermore, FIG. 11A is a view which breaks down the height adjustment mechanism 50 which is illustrated in FIG. 10B, FIG. 11B is a plan view after assembling the height adjustment mechanism 50 which is illustrated in FIG. 11A, and FIG. 11C is a perspective view after assembly.

One height adjustment mechanism 50, as illustrated in FIG. 10A, is provided at each of the start point side and the end point side of the carrier 40. Further, the height adjustment mechanism 50 at the end point side is provided with a holder support arm 56 which connects the holder 42 and the carriage 41, while the height adjustment mechanism 50 at start point side is not provided with the holder support arm 56 and is provided with only the elevating wheel 44. In the carrier 40 of the second embodiment as well, the arms 51 and 52 of the two locations of the height adjustment mechanism 50, while not illustrated, may be connected to a link and made to turn synchronously in the same way as the first embodiment.

As illustrated in FIG. 10B, one end of the holder support arm 56 is attached to be able to rotate at an arm shaft 57 which is provided at a bracket 50B of the height adjustment mechanism 50 while the other end is connected to a shaft 44A of an elevator wheel 44 which is provided at the holder 42. The elevator wheel 44 runs on the contour of the cam 53 which is attached to a bracket 50B by a shaft 50B. In the present embodiment, as illustrated in FIG. 10C, the contour of the cam 53 at the intermediate part of the pin P1 and the pin P3 forms the small diameter part r with the shortest distance from the shaft 50A, while the contour of the cam 53 near the pin P2 forms the large diameter part R with the longest distance from the shaft 50A. Further, in the case of the present embodiment, the vicinity of the contour of the part which is illustrated by the reference notation r can be made an arc of a radius r centered about the shaft 50A, while the vicinity of the contour of the part which is illustrated by the reference notation R can be made an arc of a radius R centered about the shaft 50A.

The structures of the height adjustment mechanisms 50 at the start point side and the end point side are the same except for the holder support arm 56, so here the structure of the height adjustment mechanism 50 of the end point side other than the holder support arm 56 will be explained using FIG. 11A to FIG. 11C. As illustrated in FIG. 11A to FIG. 11C, the shaft 50A of the cam 53 is inserted via bearings 54 in the mounting holes 50H which are provided at the facing parts of the two side walls 50W at the brackets 50B. At the shaft 50A between the two bearings 54, a collar or stop ring and a compression coil spring 55 are attached. At the shaft 50A of the parts sticking out from the two side walls 50W, cams 53 are fastened by screws. The contours in the shaft direction of the cams 53 which are attached to the shaft 50A are the same.

Between the cam 53 at the side close to the carriage and the side wall 50W, a ring shaped felt sheet 58 is inserted. This felt sheet 58 generates friction when the cam 53 rotates and prevents the cam 53 from unintentionally rotating. Further, at a predetermined position of the outside surface of the cam 53 at the side farthest from the carriage, three pins P1, P2, and P3 are provided sticking out as abutting members. The pin P1 is formed low in height, while the pins P2 and P3 are formed higher than the pin P1. The abutting members need not be pins and can also be formed by side surfaces of the cam 53 made to stick out.

At the shaft 50A which sticks out from the outer surface of the cam 53, base end parts of the first arm 51 and the second arm 52 are attached in a state with play. The front end parts of the first arm 51 and the second arm 52 are at positions which stick out from the contour of the cam 53. Further, the front end part side of the first arm 51 is positioned between the first and second pins P1 and P2, while the base end part side of the second arm 52 is positioned between the second and third pins P2 and P3. Accordingly, the first arm 51 can freely turn in a range which is limited by the pin P1 and the pin P2, while the second arm 52 can freely turn in a range which is limited by the pin P2 and the pin P3.

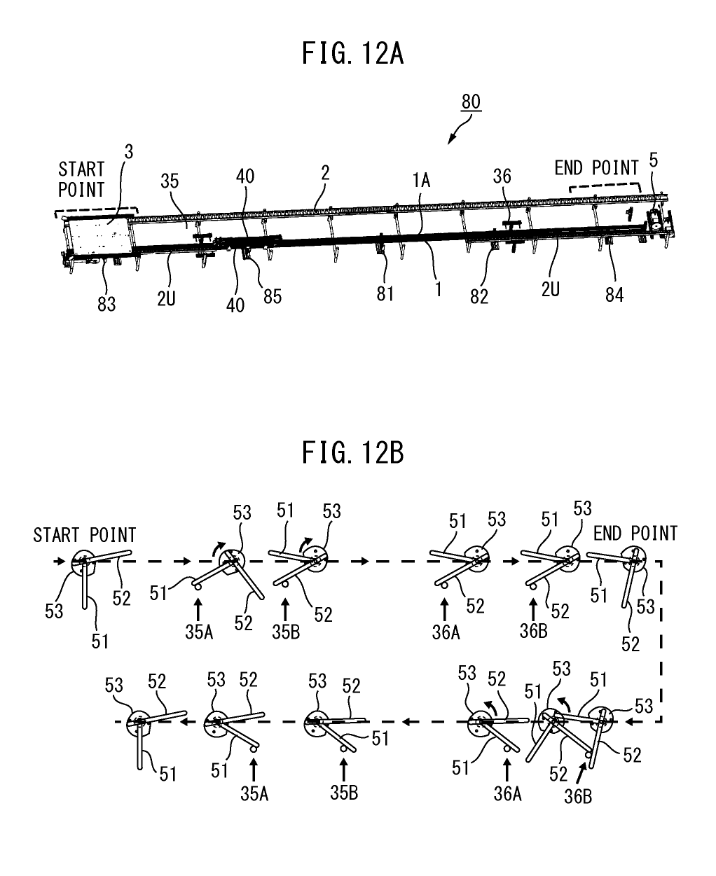

FIG. 12A illustrates the overall configuration of a conveyor system 80 which is provided with rails 1 and 1A and a roller track 2 over which carriers 40 of the second embodiment of the present application move back and forth. At the start point, there is a pallet 3 as a part which a carrier 40 transports. On the rails 1 and 1A, there are carriers 40 which are controlled in running by motors 5. Further, in the conveyor system 80 of this embodiment, as sensors which detect the positions of the carriers 40, there are standby position sensors 81, operating bar passage detection sensors 82, start point sensors 83, and end point sensors 84. Furthermore, in the vicinity of the start point and the vicinity of the end point, there are free roller units 2U which hold the pallets 3. In addition to this, at the sides of the rails 1 and 1A of the start point side from the standby position sensors 81, there are operating bars 35. At the sides of the rails 1 and 1A of the end point side from the standby position sensors 82, there are operating bars 36.

Here, the operation of each height adjustment mechanism 50 at the carrier 40 of the second embodiment will be explained using FIG. 12B and FIG. 13A to FIG. 13F and FIG. 14A to FIG. 14F. Note that, for explanation, it is assumed that the carrier 40 runs in a state where a pallet is not carried.

In the same way as the carrier 20 which was explained in the first embodiment, when the carrier 40 of the second embodiment is at the start point, the holder 42 approaches the carriage 41 in state. When reaching the end point, the holder 42 is most separated from the carriage 41 in state. Further, the operating bar 35 which is illustrated in FIG. 12A acts on each height adjustment mechanism 50 of the carrier 40 which departs from the start point to make the holder 42 rise in position from the carriage 41. Further, the operating bar 36 at the end point side acts on each height adjustment mechanism 50 of the carrier 40 which returns from the end point to the start point to make the holder 42 approach the carriage 41 in position.

Note that, the height adjustment mechanism 30 of the carrier 20 of the first embodiment is provided with only one arm 33, but the height adjustment mechanism 50 of the carrier 40 of the second embodiment is provided with the two arms of the first and second arms 51 and 52. For this reason, in the conveyor system 80 which is provided with the carriers 20 of the first embodiment, one each of the operating bars 35 and 36 was sufficient, but in the conveyor system 80 which is provided with the carriers 50 of the second embodiment, two each of the operating bars 35 and 36 were necessary. Accordingly, in the conveyor system 80 which is provided with the carriers 50 of the second embodiment, the operating bars 35 and 36 are respectively provided with the first operating bars 35A and 36A and the second operating bars 35B and 36B.

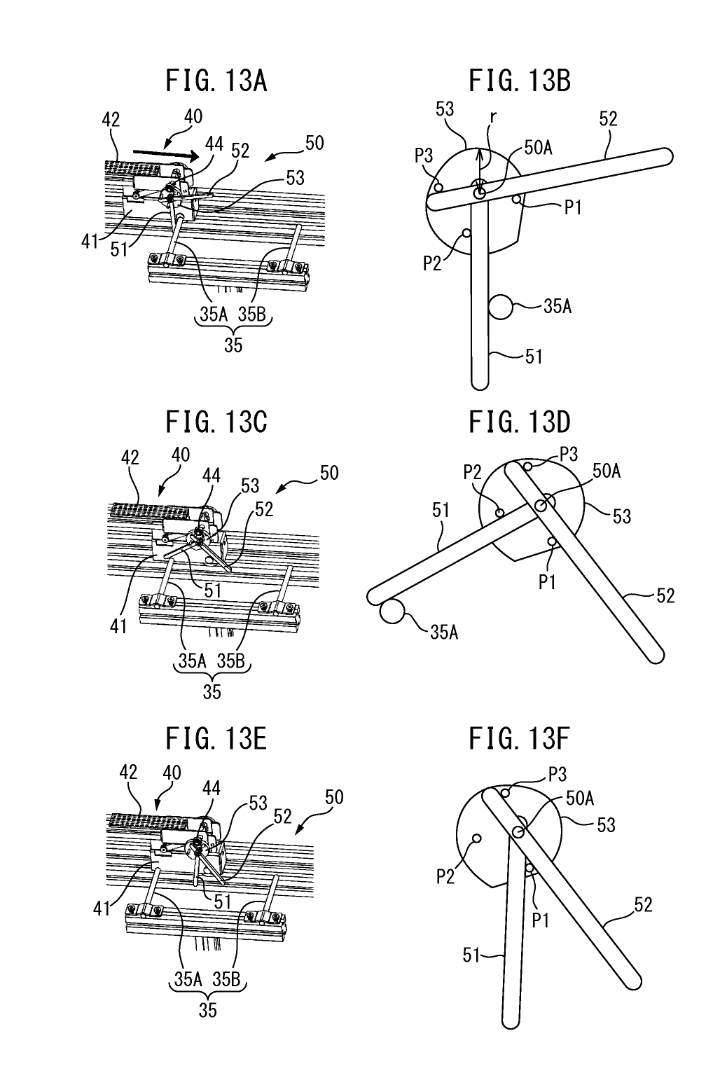

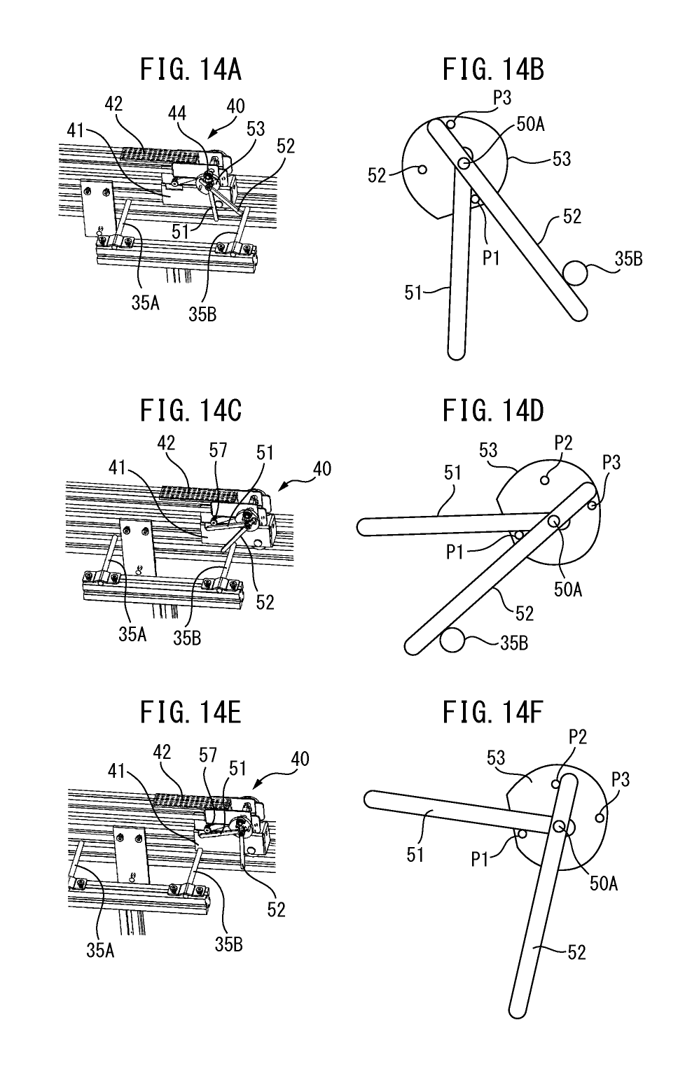

Further, when the carrier 40 is at the start point, the cam 53 is in the state with the small diameter part r facing straight up. The state at this time is illustrated in FIG. 13A. The first arm 51 can freely turn with respect to the shaft 50A, but, in this state, the first arm 51 is limited in rotation by the pin P2. Further, the second arm 52 can also freely turn with respect to the shaft 50A, but, in this state, the second arm 52 is limited in rotation by the pin P3.

If a carrier 40 departs from the position of the start point which is illustrated in FIG. 12B toward the end point, as illustrated in FIG. 13A and FIG. 13B, the first arm 51 of the height adjustment mechanism 50 abuts against the first operating bar 35A. If the carrier 40 continues running, the first arm 51 is pushed by the first operating bar 35A and turns clockwise. If the first arm 51 turns clockwise, as illustrated in FIG. 12B, FIG. 13C, and FIG. 13D, the pin P2 which abuts against the first arm 51 is made to turn clockwise, so the cam 53 turns clockwise. Further, along with turning of the cam 53, the second arm 52 which is limited in rotation by the pin P3 turns clockwise along with the pin P3.

If the carrier 40 continues running, the first arm 51 passes the first operating bar 35A and the height adjustment mechanism 50 enters the region between the first operating bar 35A and the second operating bar 35B. This state is illustrated in FIG. 13E and FIG. 13F. If the first arm 51 passes the first operating bar 35A, the first arm 51 naturally falls since it can freely rotate with respect to the shaft 50A, strikes the pin P1, and stops rotating. On the other hand, the cam 53 is held by friction by the above-mentioned felt sheet, so holds the final position which it was rotated to by the first arm 51. Further, the position of the second arm 52 is no different from the state of FIG. 13D, but if the second arm 52 turns to this position, the position of the front end part of the second arm 52 becomes lower than the position of the second operating bar 35B.

If the carrier 40 continues running, as illustrated in FIG. 12B, FIG. 14A, and FIG. 14B, the second arm 52 of the height adjustment mechanism 50 strikes the second operating bar 35B. Due to subsequent running of the carrier 40, the second arm 52 is pushed by the second operating bar 35B and turns clockwise. If the second arm 52 is turned clockwise, as illustrated in FIG. 12B, FIG. 14C, and FIG. 14D, the pin P3 which strikes the second arm 52 is made to turn clockwise, so the cam 53 rotates clockwise. Further, along with rotation of the cam 53, the first arm 51 which was limited in turning by the pin P1 turns clockwise along with the pin P1.

If the carrier 40 continues running, the second arm 52 passes the second operating bar 35B. This state is illustrated in FIG. 14E and FIG. 14F. If the second arm 52 passes the second operating bar 35B, the second arm 52 naturally falls since it can freely rotate with respect to the shaft 50A, so the base part strikes the pin P2 and stops rotating. On the other hand, the cam 53 is held by friction by the above-mentioned felt sheet, so holds the final position which it was rotated to by the second arm 52. Further, the position of the first arm 51 is held at the position where it was turned by the second arm 52 and strikes the pin 1.

If the carrier 40 approaches the end point, the first arm 51 and the second arm 52 approach the first operating bar 36A while holding the state of FIG. 14F and only the second arm 52 strikes the first operating bar 36A and turns. However, the range of turning of the second arm 52 which turns due to the first operating bar 36A is the same as the range by which the second operating bar 35B causes the second arm 52 to turn, so even if the second arm 52 passes the first operating bar 36A, the cam 53 does not rotate more than that.

Due to the further approach of the carrier 40 to the end point, the first arm 51 and the second arm 52 approach the second operating bar 36B while maintaining the state of FIG. 14F and only the second arm 52 strikes the second operating bar 36B and turns. However, in this case as well, the range of turning of the second arm 52 which turns due to the second operating bar 36B is the same as the range by which the first operating bar 35A causes the second arm 52 to turn, so even if the second arm 52 passes the second operating bar 36B, the cam 53 does not rotate more than that.

The carrier 40 which has reached the end point due to the above operation, as illustrated in FIG. 12B, returns toward the start point. At this time, the second arm 52 strikes the first and second operating bars 36B and turns counterclockwise to push against the pin P2 to make the cam 53 rotate counterclockwise and make the first arm 51 turn counterclockwise until a position striking the first operating bar 36A. This being so, next, the first arm 51 strikes the first operating bar 36A to turn counterclockwise and pushes against the pin P1 to make the cam 53 turn counterclockwise. Due to the counterclockwise rotation of the cam 53, the holder 42 of the carrier 40 approaches the carriage 41.

When a carrier 40 which departs from the end point passes the operating bar 36, rotation of the cams 53 cause the holder 42 to approach the carriage 41 and the holding surface of the holder 42 which holds the material to descend in height. Accordingly, after this, even if the carrier 40 which returns to the start point passes another carrier 50 which transports material from the start point to the end point, the holding surface of the holder 42 which holds the material does not strike the material which is held and transported by the other carrier 40. In the present embodiment as well, the operating bars 35 and 36 need only be provided with the function of making the arms 33 turn, so are not limited to bar-shaped members and may also be plate shaped.

In each height adjustment mechanism 30 which is provided at the carrier 20 of the first embodiment, there is a single arm which makes a cam rotate, so the angle of rotation of the cam becomes smaller than the angle of rotation of the arm and the cam cannot rotate by a sufficient angle of rotation. On the other hand, in each height adjustment mechanism 50 which is provided at the carrier 40 of the second embodiment, it is possible to increase the number of arms which make the cam rotate to two to thereby increase the angle of rotation of the cam. Furthermore, by using in common the two pins which limit the range of movement of the first arm and one of the two pins which limit the range of movement of the second arm, it is possible to reduce the number of the pins.

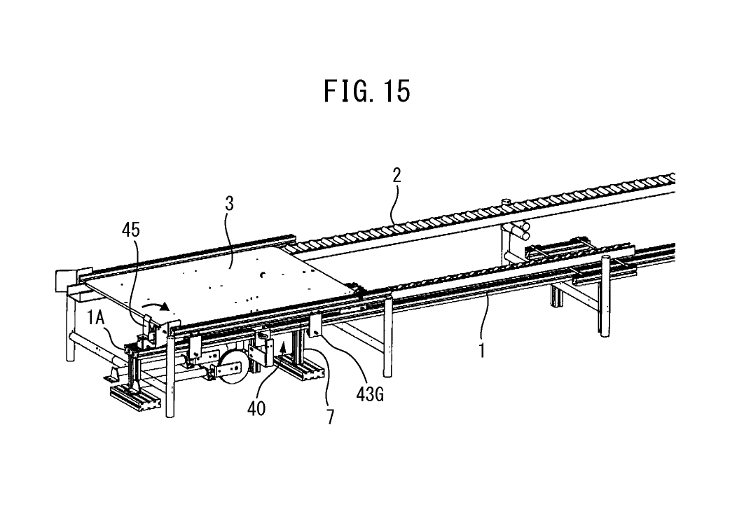

FIG. 15 illustrates the operation of a ratchet stopper 45 of the start point side which is provided at the carrier 40 of the present application. A ratchet stopper 45 is also provided at the end point side. The ratchet stopper 45 can turn in the illustrated arrow direction. Therefore, when the carrier 40 conveys material (pallet 3) from the start point to the end point, when departing from the start point of the carrier 40, the material is prevented from slipping backward from the carrier 40. Further, when the carrier 40 returns from the end point to the start point, even if the ratchet stopper 45 abuts against the material being conveyed from the start point to the end point, it turns in the arrow direction and is knocked down, so can pass under the material.

Note that, when the frictional force between the material (pallet 3) and the carrier 40 is small, it is possible to provide rubber on the carrier 40 etc. to increase the frictional force and prevent the material (pallet 3) from slipping in a direction perpendicular to the direction of advance.

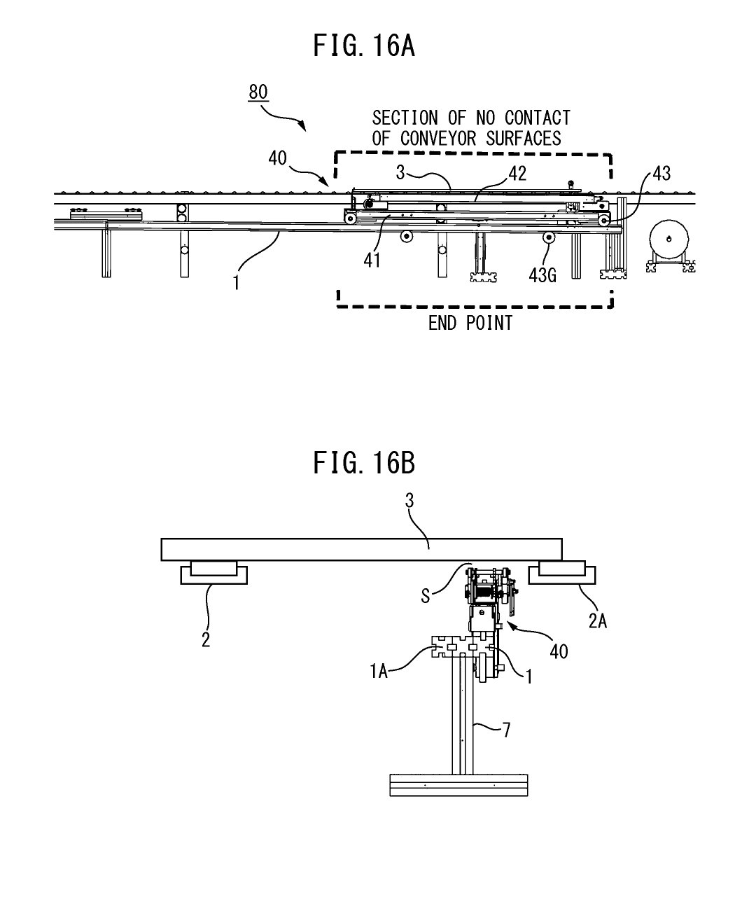

FIG. 16A illustrates one example of the structure of the rail 1 of the conveyor system 80 of the present application at the end point, while FIG. 16B is a front view which illustrates the separation of a pallet 3 from the carrier 40 in FIG. 16A. In this structure, the rail 1 of the carrier 40 is lowered to disengage so as to release the pallet 3 at the end point. Further, a separate roller track 2A is placed at a position where the carrier 40 and pallet 3 will not contact at the end point. Due to this structure, if conveying the pallet 3 up to the end point, the pallet 3 is held at the two roller tracks 2 and 2A, a space S is formed with the carrier 40 so no contact occurs any longer, and the pallet 3 can be easily taken out.

Note that, in conveyor system 80 of the structure which is illustrated in FIG. 12A, when the carrier 40 is at the end point and, in that state, the next carrier 40 transports material and moves to the end point, the transport surface of the carrier 40 which is at the end point remains raised, so the carrier 40 strikes the material. Therefore, when the prior departing carrier 40 is at the end point, the next departing carrier 40 stops at the standby position sensor part. This control may be performed in the same way as the first embodiment, so the explanation is omitted.

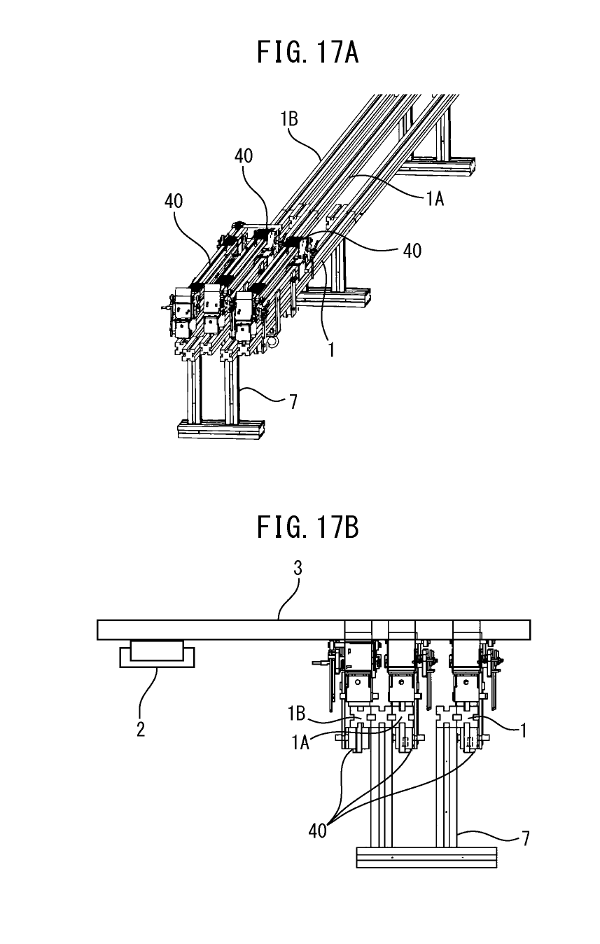

In the above explained embodiment, the rail 1 and the rail 1A were provided to run two carriers. On the other hand, as illustrated in FIG. 17A and FIG. 17B, it is possible to provide more than two carriers 40. When providing three carriers 40, a third rail 1B is provided at a position from the existing rails 1 and 1A where there will be no interference of the carriers. By providing three carriers 40 in this way, it is possible to further increase the number of transports. Further, four or more rails can be set. When increasing the carriers and the rails, in the same way as when there are two carriers and two rails, it is possible to detect the positions of the carriers by sensors and perform control so that the parts do not collide.

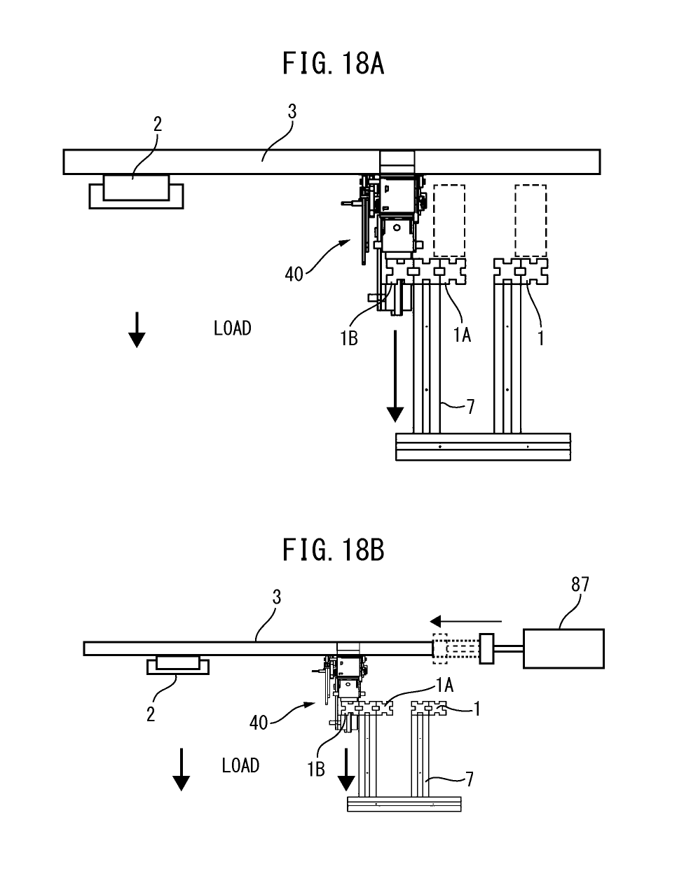

In this regard, the numbers of carriers and rails were increased, but if not changing the positions of the pallets 3, if using the outside rail 1 and roller track 2 to hold a pallet 3, the load of the pallet 3 is equally applied to the rail 1 and the roller track 2. On the other hand, if using the innermost side rail 1B and roller track 2 to hold a pallet 3, as illustrated in FIG. 18A, the carrier 40 which runs on the rail 1B supports the vicinity of the center of the pallet 3. In this case, due to the load which is applied to the roller track 2, the load which is applied to the carrier 40 becomes greater and the holding state of the pallet 3 becomes unstable.

In such a case, as illustrated in FIG. 18B, it is sufficient to arrange an actuator 87 which can change the position of the pallet 3 at the start point and pushing the pallet 3 to change its position to thereby make the load of the pallet 3 be equally applied to the rail 1B and the roller track 2. Due to the arrangement of the actuator 87, the issue of instability of the balance of the load due to the position of the used carrier when the carriers increase and the width of the load is narrow can be dealt with.

In this way, the conveyor system of the present application does not require the increase of the number of conveyor lines even if increasing the amount of transport. It is possible to deal with a desired increase of the amount of transport by a single line's worth of structures of a conveyor line without increasing the installation area of the conveyor lines. Further, it is also possible to increase the number of rails and control the plurality of carriers so as to realize various modes of conveyance. That is, it is possible to independently control a plurality of carriers, so when one carrier is disabled from conveyance, it is possible to suspend the transport of that one carrier and use the remaining carriers for transport on a reduced scale and perform various other conveyance operations.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A conveyor system which transports material from a start point to an end point, comprising
a roller track which is laid from said start point to said end point and which makes said material move while holding first ends by a set of rollers,
at least two rails which are set in parallel a predetermined distance away from said roller track from said start point to said end point,
carriers which can independently run on said rails and at which other ends of said material are held, and
operating members which are provided at the sides of said start point sides and said end point sides of said rails and which engage with said carriers right after departing from said start point and said carriers right after departing from said end point to change the states of said carriers,
each said carrier comprising
a carriage which runs on said rails,
a holder which is provided at a top of said carriage and holds material, and
a height adjustment mechanism which is provided between said carriage and said holder and engages with said operating members to change a height of said holder from said carriage,
a height of said holder which said height adjustment mechanism changes to when said operating member at said end point side engages with said height adjustment mechanism being lower than a height of said holder which said height adjustment mechanism changes to when said operating member at said start point side engages with said height adjustment mechanism.

2. The conveyor system according to claim 1 wherein height adjustment mechanisms are provided at two locations of a start point side and an end point side of said carrier.

3. The conveyor system according to claim 1 wherein
said height adjustment mechanism is provided with a cam which is attached to said carriage by a shaft and which supports said holder by its contour and with an arm which is attached to said shaft and turns together with said cam, and
said operating member engages with a front end of said arm.

4. The conveyor system according to claim 3 wherein said cam
supports said holder by a contour part furthest from said shaft at the point of time when the engagement of said arm of said carrier which departs from said start point and said operating member finishes and
supports said holder by a contour part nearest from said shaft at the point of time when the engagement of said arm of said carrier which departs from said end point and said operating member finishes.

5. The conveyor system according to claim 4 wherein arms of height adjustment mechanisms which are provided at two locations of said carrier are connected by a link mechanism, and said two cams rotate while interlocked.

6. The conveyor system according to claim 4 wherein
a standby position sensor is provided at the side of each rail at the end point side from said operating member at said start point side,
an operating member passage sensor is provided at the side of each rail at the start point side from the operating member at said end point side, and
when said carrier at said start point side departs while carrying said material, if there is another carrier at said end point side, said carrier cannot pass said standby position sensor and move to said end point side until said other carrier passes said operating member passage sensor.

7. The conveyor system according to claim 1 wherein said height adjustment mechanism is provided with
a cam which is attached to said carriage by a shaft and which supports said holder by its contour,
a first arm with a base part which is loosely attached to said shaft to be able to pivot and with a base end which is positioned inside the contour of said cam,
a second arm which is positioned at a side further from said cam than said first arm and with a base end which is positioned inside the contour of said cam,
first abutting member which are provided projecting from the surface of the side of said cam at which said first and second arms are attached and which strike a base end of said first arm to limit a rotational angle of said first arm, and
second abutting members which are provided projecting from the surface of the side of said cam at which said first and second arms are attached and which strike a base end of said second arm to limit a rotational angle of said second arm,
said operating member engaging with front ends of said first and second arms.

8. The conveyor system according to claim 7 wherein one of said first abutting members is common with one of said second abutting members, while the other of said first abutting members is lower than the height of said second abutting members and does not engage with said second arm.

9. The conveyor system according to claim 8 wherein said first and second abutting members are arranged on said cam so that
at said carrier which departs from said start point, first said first arm engages with said operating member whereby said cam rotates by a first operation and said second arm moves to an engagement position with said operating member, next said second arm engages with said operating member whereby said cam rotates by a second operation, and, when engagement of said second arm and said operating member ends and said cam finishes rotating by the second operation, the contour part farthest from said shaft supports said holder and so that
at said carrier which departs from said end point, first said second arm engages with said operating member whereby said cam rotates by a third operation and said first arm moves to an engagement position with said operating member, next said first arm engages with said operating member whereby said cam rotates by a fourth operation, and, when engagement of said first arm and said operating member ends and said cam finishes rotating by the fourth operation, the contour part nearest from said shaft supports said holder.

10. The conveyor system according to claim 9 wherein said first and second arms of said height adjustment mechanisms which are provided at two locations of said carrier are connected by a link mechanism and said two cam rotate while interlocked.

11. The conveyor system according to claim 9 wherein
said holder is provided with a wheel which runs on a contour of said cam by a shaft, and
a link is attached between one end of the shaft of said wheel and another shaft which is provided at said carriage.

12. The conveyor system according to claim 1 wherein a surface of said holder on which said material is placed is provided with a stopper which prevents said material from sticking out from said carrying surface.

13. The conveyor system according to claim 1 wherein
said end point is provided with a support plate which supports the other end of said material which was transported by said carrier so to be separated from said holding surface of said material of said holder, and
the portion of said rail at said end point is provided with a gradient part, and said rail is positioned below said support plate.

14. The conveyor system according to claim 1 wherein said start point is provided with an actuator which shifts the position of said material to said roller track side so that said material is held by said roller track and said carrier with a good balance when the other end of said material is carried on said carrier which runs on a rail at a side close to said roller track.

15. The conveyor system according to claim 1 wherein said material is a pallet which is held by said roller track and said carrier and a member which requires transport which is carried on said pallet.

16. The conveyor system according to claim 1 wherein said height adjustment mechanism holds a height of said holder from said carriage which was changed by engagement with said operating member until next engaging with said operating member.
